(19) United States
(12) Patent Application Publication
(10) Pub. No.: US 2013/0013416 A1
(43) Pub. Date: Jan. 10, 2013

(54) DISPLAYING ADVERTISEMENTS RELATED TO BRANDS INFERRED FROM USER GENERATED CONTENT

(76) Inventor: Melissa B. Stein, Sherman Oaks, CA (US)

(21) Appl. No.: 13/176,624

(22) Filed: Jul. 5, 2011

(51) Int. Cl. G06Q 30/00

(52) U.S. Cl. 705/14.66; 705/14.49

(57) ABSTRACT

A method, system, and computer program product for displaying a digital advertisement within a digital context using brand name recognition from user generated content. The method commences by receiving an ad call, the ad call having at least a portion of a publisher digital context and the ad call having at least a portion of user generated content. Then, having the ad call, the method commences by parsing the user generated content, the user generated content being at least partially included in an ad call. Once parsed, then identifying at least one brand association using the portion of the user generated content, and scoring a match between the brand association and at least one candidate digital advertisement, the match determined using at least one matching algorithm. A matched candidate digital advertisement is displayed on a display device.

### FIELD OF THE INVENTION

The present invention relates generally to internet advertising, more specifically to targeting advertisements using user generated content.

### BACKGROUND OF THE INVENTION

In many internet contexts, it is common for users to visit a publisher's website, and there discuss products and services with other users in their social graph. The users may also embed URLs and/or share links to products and services that the users may want their friends and family to consider. This activity is known as “earned media”, and often results in value accruing to the brand. Although the activity accrues value to the brand, often the revenue that should accrue to the publisher is not tracked and paid to the publisher.

More specifically, even though user generated content (e.g. discussions, posts) may refer to brand names, and even though user generated content may contain opinions about brands (or products related to a brand), placement of advertising or messages relevant to the aforementioned user posts, and therefore the monetization of these activities, has not yet been been fully exploited, creating an imbalance of payments.

This imbalance of payments is poised to widen since user generated content such as posts and discussions are on the rise.

Accordingly, there exists a need for overcoming the abovementioned and other limitations in order to facilitate displaying advertisements related to brands inferred from user generated content.

### SUMMARY OF THE INVENTION

A method, system, and computer program product for displaying a digital advertisement within a digital context using brand name recognition from user generated content. The method commences by receiving an ad call, the ad call having at least a portion of a publisher digital context and the ad call having at least a portion of user generated content. Then, having the ad call, the method commences by parsing the user generated content, the user generated content being at least partially included in an ad call. Once parsed, then identifying at least one brand association using the portion of the user generated content, and scoring a match between the brand association and at least one candidate digital advertisement, the match determined using at least one matching algorithm. A matched candidate digital advertisement is displayed on a display device.

### BRIEF DESCRIPTION OF THE DRAWINGS

The novel features of the invention are set forth in the appended claims. However, for purpose of explanation, several embodiments of the invention are set forth in the following figures:

FIG. 1A depicts a publisher digital context showing headlines within a browser window, according to one embodiment.

FIG. 1B depicts a publisher digital context showing icons within a browser window. The publisher digital context can be displayed, according to one embodiment.

FIG. 1C depicts a publisher digital context showing a conversation area within a browser window, according to one embodiment.

FIG. 1D depicts a publisher digital context showing a digital advertisement within a display window, according to one embodiment.

FIG. 1E depicts a publisher digital context showing an article within a display window, according to one embodiment.

FIG. 1F depicts a publisher digital context showing an ad within a display window, according to one embodiment.

FIG. 2A depicts an advertising server network environment including components of a system for displaying advertisements related to brand names within a publisher's website, according to one embodiment.

FIG. 2B depicts an advertising server network environment including experience management components of a system for displaying advertisements related to brand names within a publisher's website, according to one embodiment.

FIG. 3 is a depiction of an exemplary user context profile data structure, according to one embodiment

FIG. 4 is a depiction of an exemplary publisher context profile data structure, according to one embodiment.

FIG. 5 depicts components of a system for displaying advertisements related to brands inferred from user generated content, according to one embodiment.

FIG. 6 depicts a block diagram of a system for displaying a digital advertisement within a digital context, according to one embodiment.

FIG. 7 is a diagrammatic representation of a network, including nodes for client computer systems, nodes for server computer systems, and nodes for network infrastructure, according to some embodiments.

### DETAILED DESCRIPTION

In the following description, numerous details are set forth for purpose of explanation. However, one of ordinary skill in the art will realize that the invention may be practiced without the use of these specific details. In other instances, well known structures and devices are shown in block diagram form in order to not obscure the description of the invention with unnecessary detail.

### DEFINITIONS

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad call” means a message sent by a computer to an ad server for requesting a digital advertisement to be displayed.

“Ad click-through rate” (e.g. click-through rate) means a measurement of ad clicks per a period of time.

“Ad server” is a server that is configured for serving one or more ads to user devices. An ad server is preferably controlled by a publisher of a website and/or an advertiser of online ads. A server is defined below.

“Advertiser” (e.g. messenger and/or messaging customer, etc) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for deducing shadow profiles.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Conversion” (e.g. ad conversion) means a purchase of a product/service that happens as a result of a user responding to an ad and/or a coupon.

“Database” (e.g. database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may include one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Digital Context” means a web page or a display of digital content using a downloadable application.

“Impression” (e.g. ad impression) means a delivery of an ad to a user device for viewing by a user.

“Item” means an ad, which is defined above.

“Message” means an ad, which is defined above.

“Messaging” means advertising, which is defined above.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, a web page, an downloadable application and/or other digital context having digital content and/or digital ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Social graph” means the relationships between individuals communicating in an online environment and relative to all connections involved.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“User generated content” (e.g. a post, a comment, a discussion, etc) means any content generated by a user for inclusion in a web page. User generated content may refer to a brand by name, and may contain opinions about brands (or products related to a brand).

“Web browser” means a software program that may display text or graphics or both, from digital contexts. Examples of a web browser include, without limitation, Mozilla Firefox™ and Microsoft Internet Explorer™

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator). “Web portal” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo!™) have transformed themselves into web portals to attract and keep a larger audience.

“Web server” is a server configured for serving at least one digital context to a display device. An example of a web server is a Yahoo!™ web server. A server is defined above.

“Website” means one or more digital contexts. A website preferably includes a plurality of digital contexts virtually connected by links or URL addresses to form a coherent group.

### Motivation for Determining the Commercial Intent of Discussions Between Users in a Social Graph Focused on the Mention of Product Brands

In many internet contexts, it is common for users to visit a publisher's website, and there discuss products and services with other users in their social graph. The users may also embed URLs and/or share links to products and services that the users may want their friends and family to consider. This activity is known as “earned media”, and often results in free media accruing to the brand. Earned media can come in many forms within the internet (e.g. via published and re-published pages by a publisher), as well as by word-of-mouth. Although the activity accrues value to the brand, often the value of this “viral form” is not shared by the publisher. That is, whereas many publisher's websites host advertisements as a means to generate revenue, and whereas in traditional models, advertisers pay these publishers (e.g. on a cost-per-impression basis, a cost-per-click basis, or on a cost-per-action-accomplished basis), a billable event (e.g. for billing to the advertiser) might only be created if and when an advertisement is actually displayed in an impression to a user satisfying a particular set of characteristics.

In many internet contexts, internet website publishers are importing social media into their sites, yet, as just described, may not be able to participate in the revenue stream even though they are providing a channel for advertising. A desire to monetize value for (at least) the provision of a channel for advertising motivates publishers and brand owners alike to associate (e.g. match) a user comment (e.g. a user post) to a brand, display a digital advertisement to one or more visitors to the publisher's website (e.g. a visitor satisfying a particular demographic feature set or other characteristic), and thereby establish the fact of actual delivery of advertising to the target segment valued by the brander.

One way to do so is to match the brand and comments of the brand or product, and then display an ad to the user. Another way is to match the brand and comments of the brand or product, and then display an ad to other users who are viewing or otherwise expressing an interest in the user's post. For example, a user might go to “Yahoo! Finance” (e.g. www.yahoo.com/finance) and post a comment. Then a system can parse the comment, determine a relationship of the comment to a brand, match an ad, display the matching ad, and document the delivery of an impression containing a paid ad. There are many techniques to determine a relationship of the comment to a brand, some of which are based on the text of the post, and an intersecting match to words or phrases found in known databases (e.g. key classes, branding themes, etc).

For example, a post can be matched to an ad as follows:
1. Determine from the text of the post, the brand name by occurrence of reference or text related to the brand name in the post.
2. Match the determined brand name to a set of brands (e.g. look up the brand name in a list).
3. Display an ad for the brand.
   As another example, a post can be matched to an ad as follows:
1. Determine the brand name referred to in the post by using a hand-coded rule set (e.g. “M3” can be hand coded as being in association with a target brand name “BMW”).
2. Display an ad for the target brand.
   As another example, a post can be matched to an ad as follows:
1. Create a corpus of trademark “terms” as a training set such that machine learning techniques can be deployed to further learn the names of brands and related contexts.
2. Determine, from the text of the post, if the post contains any of the learned brand names (e.g. by occurrence of, or in reference to, the learned brand name in the post).
3. Match the determined brand name to a set of brands for which there may exist a repository of paid ads.
4. Display an ad for the brand.
   As another example, a post can be matched to an ad as follows:
1. Using a search log (e.g. from a search engine), create a corpus of trademark “terms” as a training set such that machine learning techniques can be deployed to further learn the names of brands and related contexts.
2. Determine, from the text of the post, if the post contains any of the learned brand names (e.g. by occurrence of, or in reference to, the learned brand name in the post).
3. Match the determined brand name to a set of brands for which there may exist a repository of paid ads.
4. Display an ad for the brand.
   As yet another example, a post can be matched to an ad as follows:
1. Using ad placement logs, create a corpus of trademark “terms” as a training set such that machine learning techniques can be deployed to further learn the names of brands and related contexts.
2. Determine, from the text of the post, if the post contains any of the learned brand names (e.g. by occurrence of, or in reference to, the learned brand name in the post).
3. Match the determined brand name to a set of brands for which there may exist a repository of paid ads.
4. Display an ad for the brand.

Various embodiments disclosed herein implement techniques to compare the information in a user post (e.g. possibly including an embedded URL) with a known set of ads. If there is a match (further described below), then the publisher displays the advertiser's advertisement to the user (and/or to other users who are in some way associated to the user's post), and thus be able to record the display event, which in turn can result in the publisher receiving revenue from the advertiser or from the advertiser's agent. This fee may be based on a negotiated share of revenue from a resulting purchase, or may be a flat fee based on the specific event (e.g. a cost per impression event), or may be based on the event of an occurrence of a post mentioning the brand (e.g. by name or by URL/link, etc), or the fee may be included in an overall advertising contract. Still more, the fee based on the specific event can include events related to promulgation of “likes” or occurrence of social media activities using the brand (e.g. activities involving instant messages and email).

A publisher accruing earned media and/or other accrued value(s) by displaying advertisements related to brands inferred from user generated content might be in a position to offer additional permitted tracking of the types of users who would buy their products. Such permitted tracking can then be used for future campaign targeting. Moreover, Such permitted tracking data can also be used for campaign optimization for advertising being displayed on the publisher's website.

In some embodiments, a publisher may further promote social activity with some association to an advertiser's offerings in order to increase engagement (e.g. promoting user posting(s) to include user generated content). Some embodiments further deliver:
Increased publisher monetization by monetizing commercial activity that would otherwise be delivered without accruing value to the publisher.
Automated understanding of commercial intent without the need to include special code (e.g. using machine learning techniques).
Increased user tracking possibilities, which tracking can be used by advertisers for tracking users of their products and services.
Inclusion of social context activities in an advertising campaign definition and optimization.
Inclusion of affiliate marketing in an advertising campaign definition and optimization, specifically facilitating practices in which one website is rewarded for driving traffic to another website.

Users are familiar with seeing ads within most digital contexts, so seeing ads together with user generated content is not an unfamiliar experience. And, users of websites have become accustomed to seeing widgets (e.g. a thumb's up “Like” icon) or other invitations to participate in a social media activity (e.g. a posting activity, an instant messaging activity, etc), and such users have also become accustomed to seeing a wide variety of sponsored messages or advertisements on the same display surface as is the publisher's digital context.

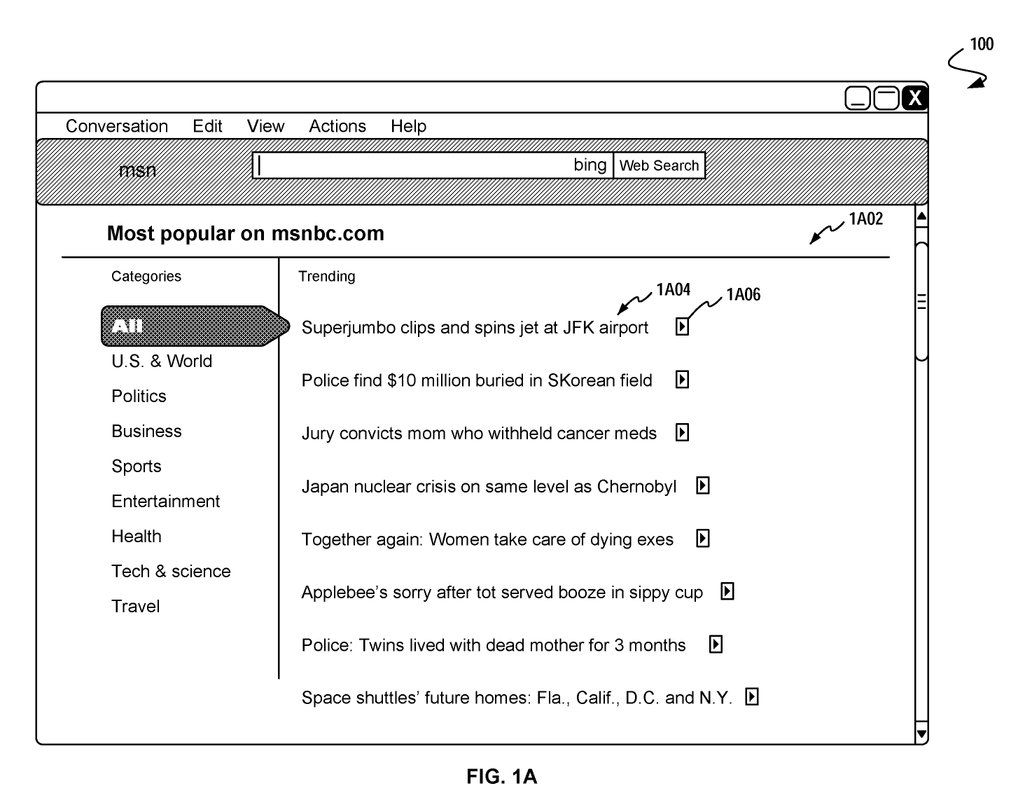

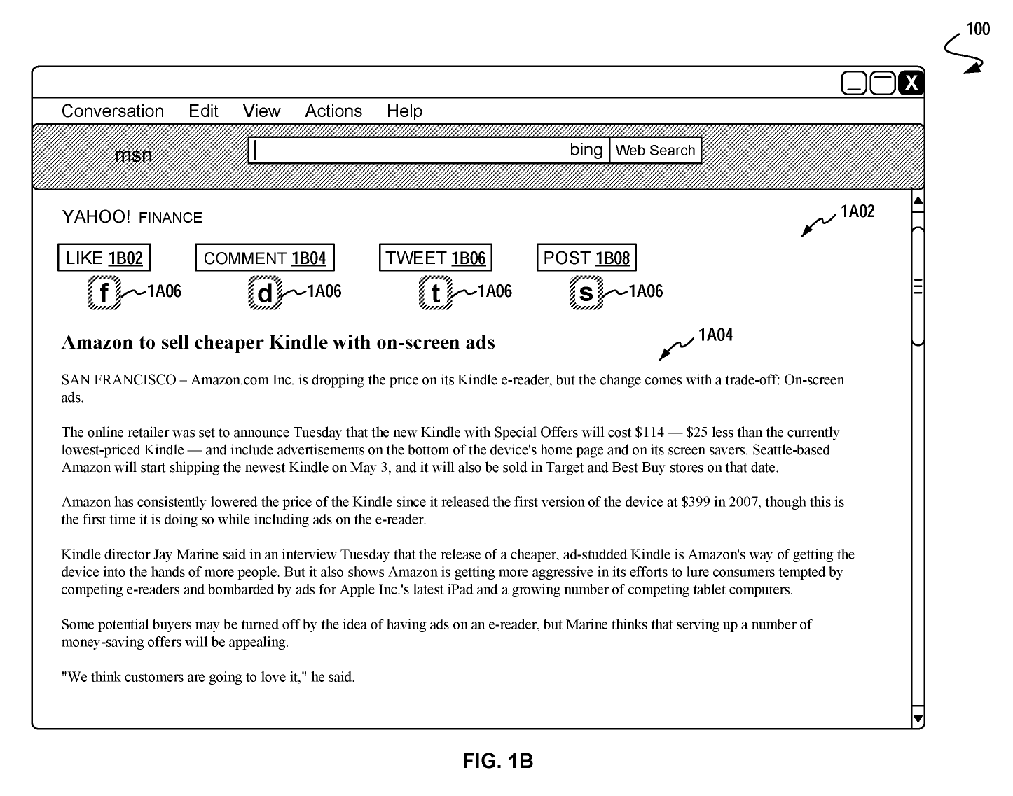

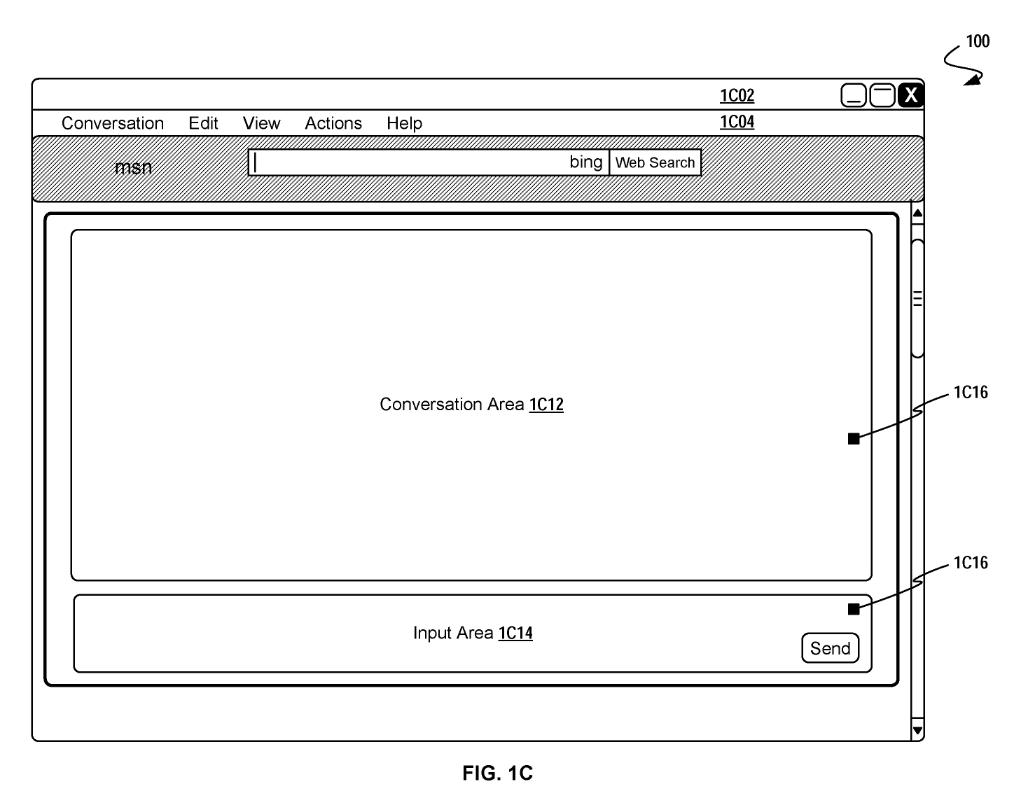

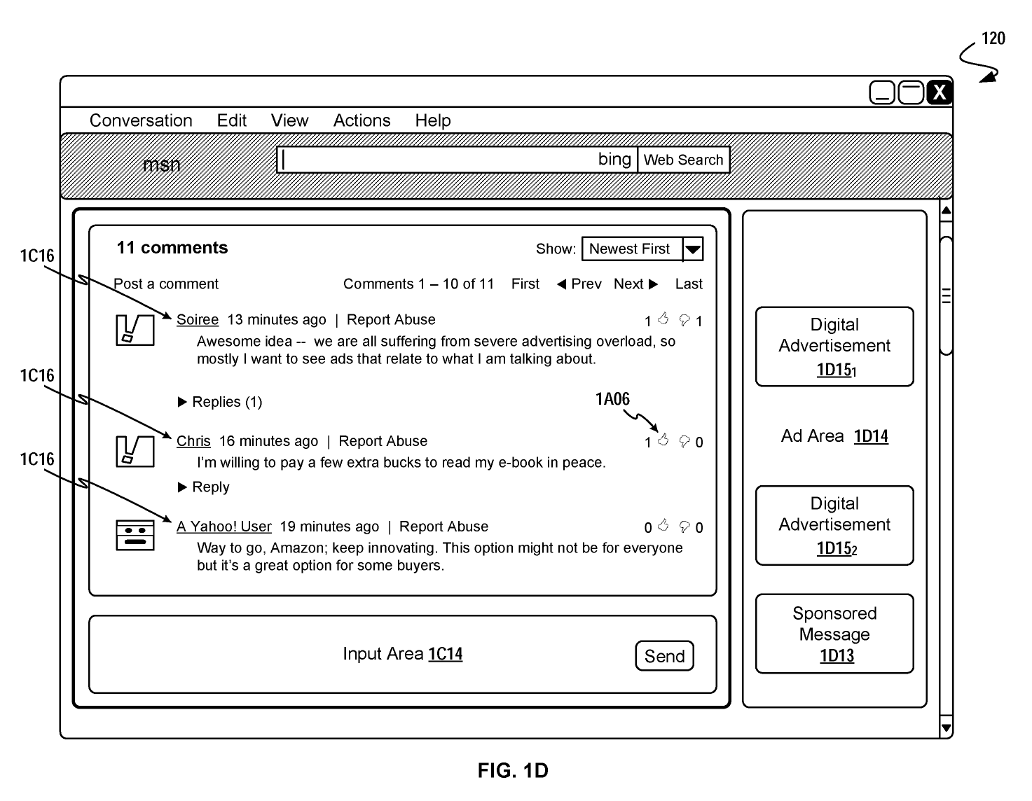

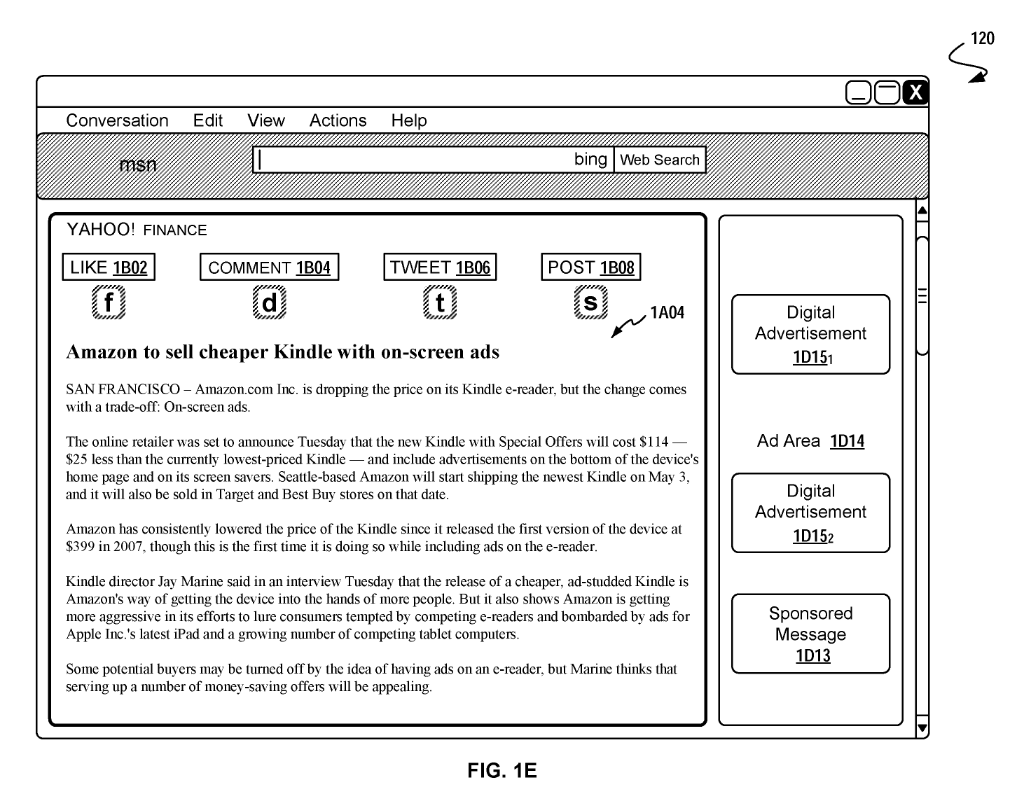

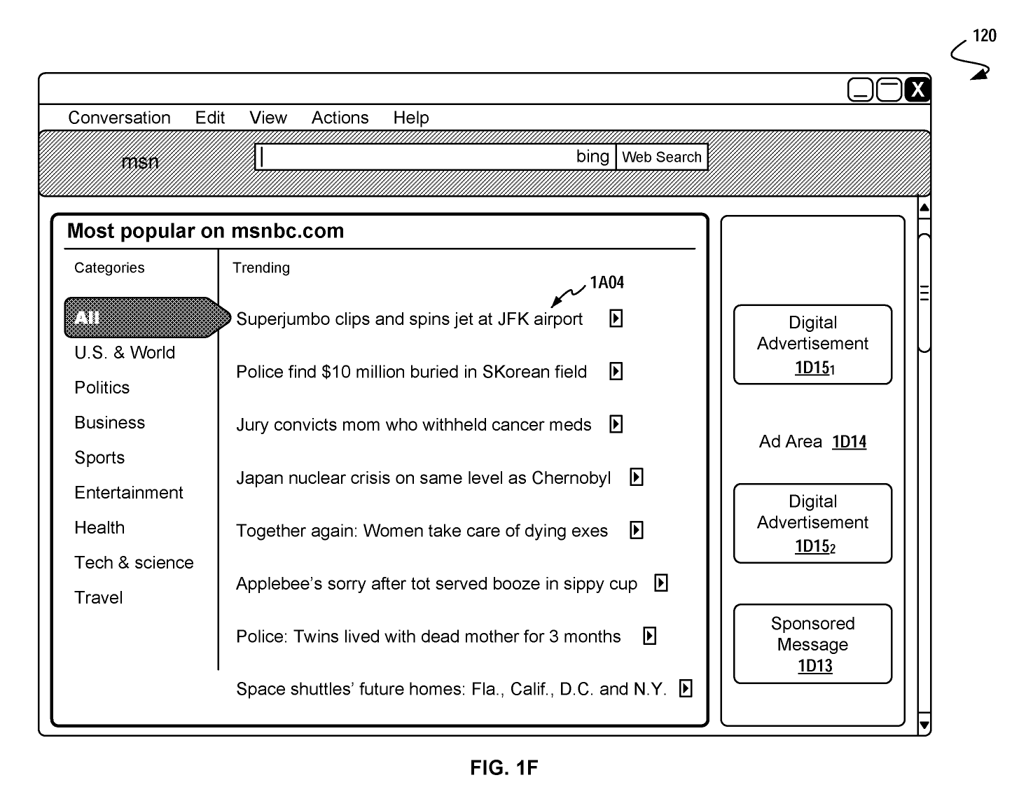

FIG. 1A depicts a publisher digital context 100 showing headlines within a browser window. The publisher digital context 100 can be displayed in a publisher digital context running on a computing device. As shown, an area is provided for displaying publisher content within a publisher digital context 100 rendered by a computing device. As shown, the display area 1A02 includes an array of instances of an interest 1A04 (e.g. text of a headline) paired with a social media icon 1A06. A social media icon 1A06 can include a mechanism for navigating to another page (e.g. to a social media digital context), or can include a mechanism for a pop-up or other display technique for a user post (e.g. an icon for “Like”, or “Vote”, or an instant message or other post).

FIG. 1B depicts a publisher digital context 100 showing icons within a browser window. The publisher digital context 100 can be displayed in a publisher digital context running on a computing device. As shown, the display area 1A02 includes an interest 1A04 in the form of an article. Also shown are instances of a social media icon 1A06 in proximity to a posting icon (e.g. a like icon 1B02, a comment icon 1B04, a tweet icon 1B06, and a post icon 1B08). As indicated in the discussion of FIG. 1A, a social media icon can include a mechanism for navigating to another page (e.g. to a social media digital context), or can include a mechanism for a pop-up or other display technique for a user post (e.g. “Like”, or “Vote”, or “Tweet”, or “Comment”, or instant message, or other post). In some situations, navigating using a social media icon 1A06 can cause the display of additional instances of a publisher digital context 100 within a browser window.

FIG. 1C depicts a publisher digital context 100 showing a conversation area within a browser window. In some embodiments, navigating using a social media icon 1A06 can cause the display of a publisher digital context 100 within a browser window, which publisher digital context can include a conversation area 1C12 and (possibly) an input area 1C14. Such a conversation area 1C12 and input area 1C14 can be used to facilitate a posting of a user generated item 1C16 (e.g. a discussion, a post, a “Like” indication, or a “Vote”, or a “Tweet”, or a “Comment”, or an instant message or other post), which post can include text, possibly text following the format of HTML, and/or can include a “Like” indication or a “Vote” indication and/or any related text relevant to a specific product or specific brand or specific user generated content.

In some embodiments, such a browser window can provide a user window control bar 1C02, the control bar including user controls such as minimize, maximize and close. And, such a window can display an application command toolbar 1C04 for providing application-specific controls. For example, an application command toolbar 1C04 can comprise commands particular to the operating of an instant messaging client software program (not shown).

In some embodiments, a dedicated screen area is provided for containing the conversation area 1C12 in which one or more conversations can be rendered as text (e.g. ASCII text, rich text, HTML-rendered text, etc). Also, in some embodiments, a dedicated screen area is provided for containing an input area 1C14 from which the content used in conversation (e.g. ASCII text, rich text, HTML-rendered text, etc) can be input and edited by the user prior to insertion into the conversation area 1C12.

As aforementioned, users have become accustomed to seeing sponsored messages or advertisements on the same display surface as an interest 1A04 or a conversation, and in some cases messages or advertisements are displayed in areas on the display surface, which areas are suited for particular types of messages or advertisements.

FIG. 1D depicts a publisher digital context 100 showing a digital advertisement within a display window. As earlier indicated, in some embodiments, navigating using a social media icon 1A06 can cause the display of a publisher digital context 100 within a window, which publisher digital context 100 can include a conversation area 1C12 and (possibly) an input area 1C14. The conversation area 1C12 and (possibly) an input area 1C14 can serve as an invitation to the user to post, and the user might indeed post using the input area 1C14. Or the user might post using a social media icon 1A06 serving as a posting icon, or in proximity to a posting icon (e.g. the thumb outline of social media icon 1A06, the like icon 1B02, the comment icon 1B04, the tweet icon 1B06, and/or the post icon 1B08).

On the (for instance) right side of publisher digital context 100 is an ad area 1D14 for a sponsored message 1D13 or digital advertisements (e.g. digital advertisement 1D15₁, digital advertisement 1D15₂, etc), which are displayed in areas on the display surface (e.g. ad area 1D14), which areas can be designed for particular types of messages or digital advertisements.

FIG. 1E depicts a publisher digital context 100 comprising a publisher digital context 100 showing an article within a display window. As earlier indicated, in some embodiments, navigating using a social media icon 1A06 can cause the display of a publisher digital context 100 within a browser window, which publisher digital context can include an interest 1A04. The interest 1A04 can in turn include an ad area 1D14 for a sponsored message 1D13 or digital advertisements (e.g. digital advertisement 1D15₁, digital advertisement 1D15₂, etc), which sponsored message and/or digital advertisements are displayed in areas on the display surface (e.g. ad area 1D14), which areas can be designed for particular types of messages or digital advertisements.

A publisher digital context 100 can include any one or more of a variety of embodiments of an interest 1A04, which interest 1A04 might be adjacent to, or otherwise on the same publisher digital context 100, as an ad area 1D14.

FIG. 1F depicts a publisher digital context 100 showing an ad within a display window. A publisher digital context 100 can include an interest 1A04 (e.g. a list of headlines, as shown), which interest 1A04 might be adjacent to, or otherwise in proximity to an ad area 1D14.

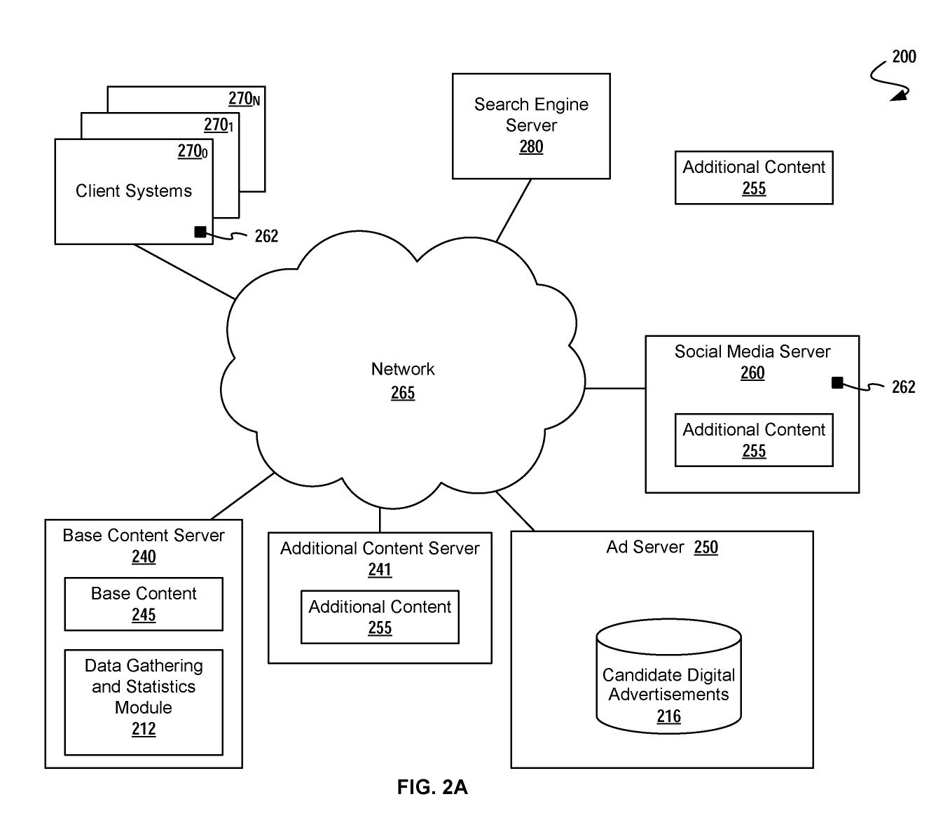

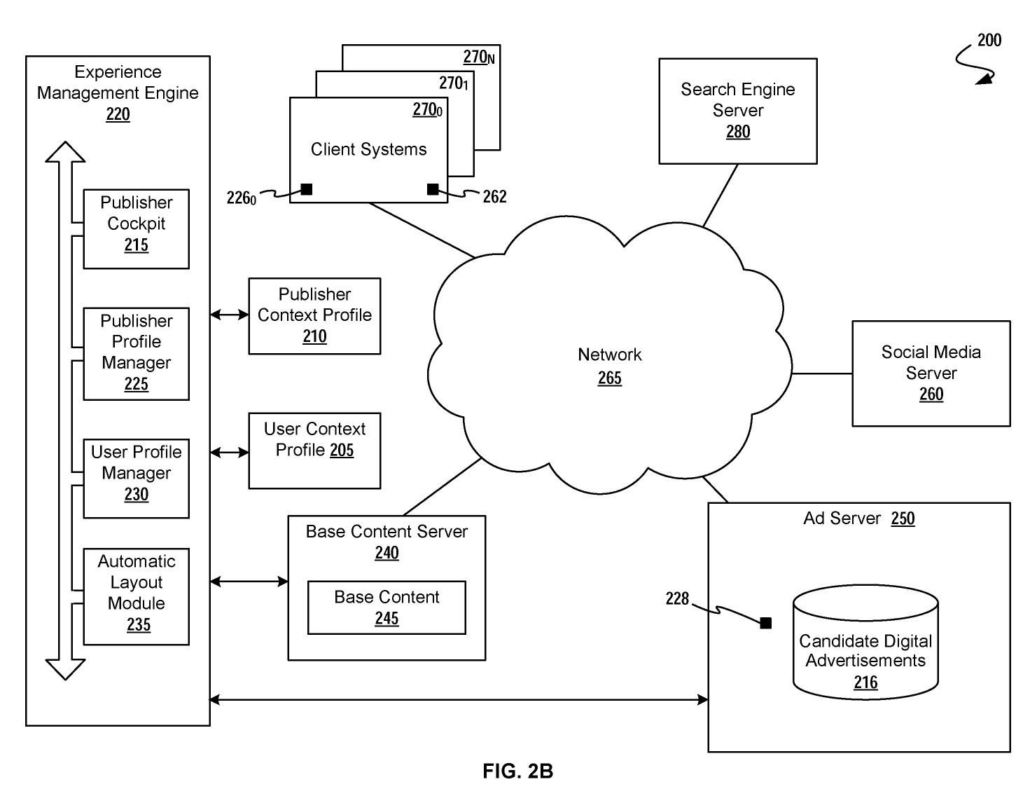

FIG. 2A depicts an advertising server network environment 200 including components of a system for displaying advertisements related to brand names within a publisher's website. In the context of internet advertising, placement of advertisements within a publisher's website using an advertising server network has become common (e.g. using servers within an advertising server network environment 200). An internet advertiser may enter into an advertising campaign including one or more ad relationships (e.g. a delivery contract) such that whenever any internet user satisfying the terms of the delivery contract visits a digital context of the publisher's website via a client system 270, the advertising system can deem the visit as an opportunity for displaying an ad, and can render the ad within a digital context as may be consistent with the terms of the delivery contract. In some cases, the digital context may be associated with a particular property (e.g. a publisher's website), and the user may have traversed to the particular property using a search engine server 280. Continuing, the advertisement is layed out within a digital context by one or more servers and modules such as a website server (e.g. a base content server 240, an ad server 250, etc) for delivery to a client system 270 over a network 265. In some cases an advertisement can be selected based on a user-generated content 262, which user-generated content is retrieved from a website server (e.g. a social media server 260) and used in the advertisement selection process.

Given this generalized delivery model, and using techniques disclosed herein, sophisticated online advertising might be practiced. More particularly, an advertising campaign might include highly customized advertisements delivered to a user corresponding to highly specific target predicates, which highly specific target predicates may correspond to a delivery contract that was booked on the basis of a query involving one or more intersecting campaign query predicates, which predicates may be related to brands inferred from user generated content.

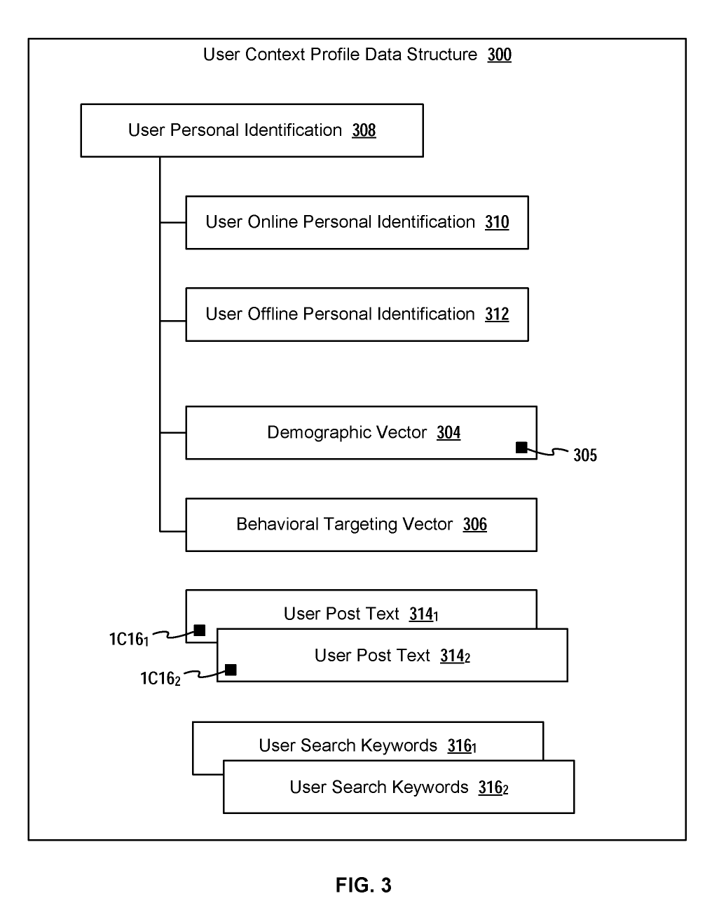

Again referring to FIG. 2A, an internet property (e.g. a publisher hosting the publisher's base content 245 on a base content server 240) might be able to measure the number of visitors that have any arbitrary characteristic, demographic feature, target predicates, or attributes, possibly using a data gathering and statistics module 212. Thus, an internet user might be ‘known’ in quite some detail as pertains to a wide range of target predicates or other attributes, and such details about the user can be captured in a data object for storing a user context profile (see FIG. 3). Moreover, one or more servers of an advertising server network (e.g. additional content server 241 within an advertising server network environment 200) can host additional content 255, and any one or more servers of an advertising server network can scan user text (e.g. user generated content, conversation area text, instant message content, and/or another digital context viewed by a user) for keywords that can then be captured in a data object for storing a user context profile, which profile can then be used in the practice of techniques to return advertisements based on what the user has been viewing.

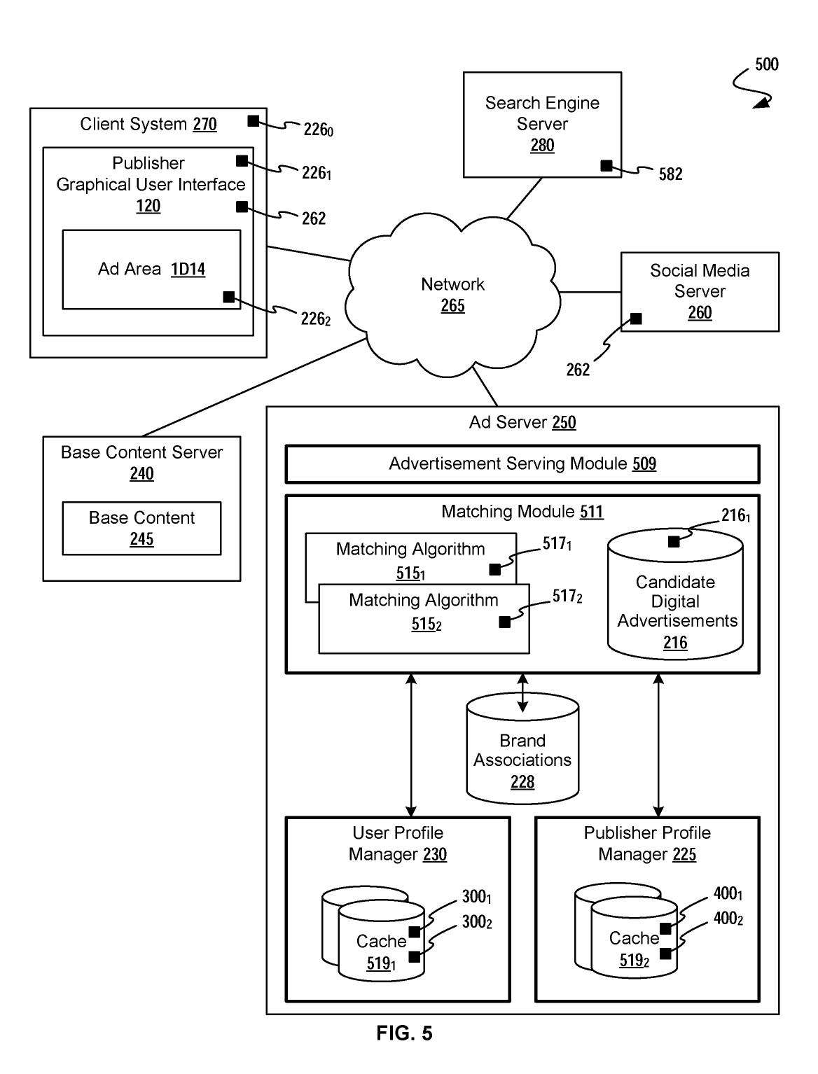

FIG. 2B depicts an advertising server network environment 200 including experience management components of a system for displaying advertisements related to brand names within a publisher's website. An advertising server network environment 200 can include experience management components (e.g. an experience management engine 220) to provide a user interface to a person acting on behalf of a publisher or a person acting on behalf of themselves. As shown, an experience management engine 220 interfaces to a base content server 240 and an ad server 250. A person acting on behalf of a publisher might interact via a publisher cockpit 215, which in turn can control aspects of an automatic layout module 235, which in turn can affect the experience of one or more users (e.g. visitors) of the website. Within various practices displaying advertisements related to brand names within a publisher's website, the experience management engine 220 can control or otherwise interact with a user profile manager 230 and/or a publisher profile manager 225. In exemplary embodiments, a publisher profile manager 225 can read/write a publisher context profile 210, and a user profile manager 230 can read/write a user context profile 205. Exemplary embodiments of a publisher context profile 210 and a user context profile 205 in the form of exemplary data structures are described more fully below. For understanding the operation of the system of FIG. 2B, a publisher context profile 210 and/or a user context profile 205 may contain at least some portion of a user post, which user post appears within impressions served from the publisher's website. For determining the precise content and layout of the impression, an automatic layout module 235 retrieves the base content 245 (e.g. interests 1A04), additional content 255 (e.g. user posts), and one or more candidate digital advertisements 216, one or more of which may have any number of brand associations 228. Moreover, the automatic layout module 235, and/or an ad server and/or an advertisement serving module (see FIG. 5) can be used for selecting from the one or more candidate digital advertisements 216.

In embodiments including the practice of displaying advertisements related to brands inferred from user generated content, one or more modules (e.g. modules within a base content server 240, modules within an ad server 250, etc) may serve to identify a brand name and/or a brand association by parsing at least a portion of the user generated content (e.g. within a user context profile 205 and/or within a publisher context profile 210). When a brand name and/or a brand association has been identified, one or more modules serve to score matches between the brand or brand association and the candidate digital advertisements, then displaying the digital context 226 on a display device.

As is understood in the art, an automatic layout module serves to layout a digital context 226 (e.g. including one or more instances of a candidate digital advertisement 216), which is then displayed on a user's display device. In exemplary cases, the one or more candidate digital advertisements 216 can be layed out within a publisher digital context within a short time frame just after a user activity from the client system results in an ad call (e.g. 100 mSec after, 200 mSec after, etc). In many cases, the selection of matching algorithms, and the execution of matching algorithms, and even the retrieval of data items used in the matching algorithms, occurs just after a user activity from the client system results in an ad call. The existence of and use of various matching algorithms are described more fully below. Data structures and use of their constituent data in matching algorithms are presently described.

FIG. 3 is a depiction of an exemplary user context profile data structure 300, according to one embodiment. A user context profile data structure 300 can be sent with (or as a part of) an ad call, and any portions of a user context profile data structure can be used by algorithms to calculate a match score (or a vector of match scores). In some embodiments, a user context profile data structure 300 is allocated within a computer memory and populated with data. An exemplary user context profile data structure 300 might comprise a field for user personal identification 308. A user personal identification 308 might in turn comprise a field for the user's online personal identification 310 and a field for the user's offline personal identification 312. Further, an exemplary user context profile data structure 300 might comprise one or more fields for a demographic vector 304 (including one or more demographic features 305) and one or more fields for a behavioral targeting vector 306, which demographic vector 304 and behavioral targeting vector 306 are used in matching algorithms to select a candidate digital advertisement 216.

As just previously described, an exemplary user context profile data structure 300 might comprise a field for user personal identification 308. Strictly as an example, a field for user personal identification 308 might comprise data from a user's cookie, or might comprise a URL to a user's profile. The user personal identification 308 might be segregated into a user's online personal identification 310 (e.g. screen name, email alias, recent search terms, etc) and/or a user's offline personal identification 312 (e.g. recent credit card purchases at a department store, a user's mobile telephone number, etc), or user personal identification might comprise only one or more pointers pointing to data within a location or locations in storage.

Some matching algorithms use one or more instances of user post text 314, and some matching algorithms use one or more instances of user search keywords 316. Any user generated content can comprise one or more instances of user post text 314 (e.g. user post text 314₁ or user post text 314₂) and can contain the text of a user post, or a portion of the text of a user post. Similarly, an instance of user search keywords 316 (e.g. user search keywords 316₁ or search keywords 316₂) can contain the text of a user search query(ies), or a portion of the text of a user search query(ies).

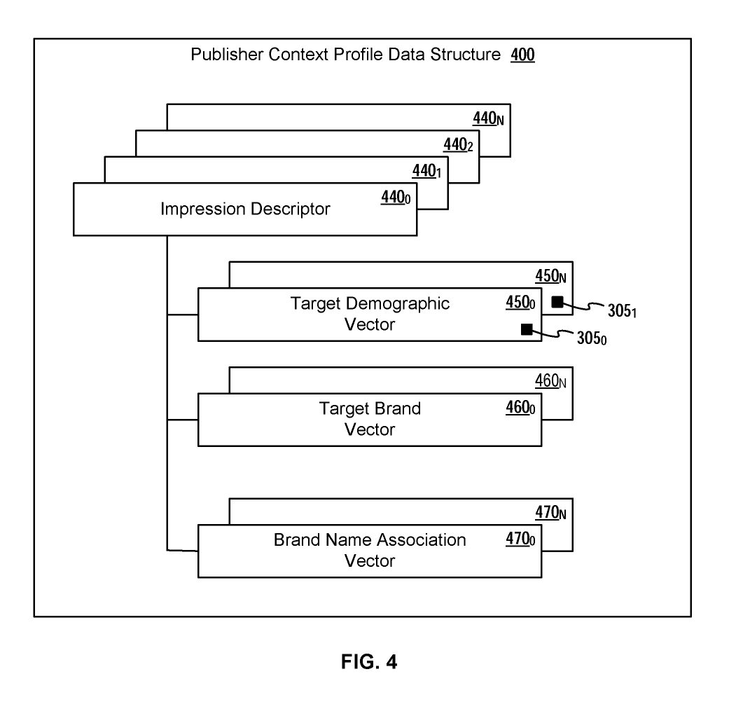

FIG. 4 is a depiction of an exemplary publisher context profile data structure 400, according to one embodiment. A publisher context profile data structure 400 can be sent with (or as a part of) an ad call, and any portions of a user context profile data structure can be used by algorithms to calculate a match score (or a vector of match scores). As earlier described, given a user context profile data structure 300 and a set of candidate digital advertisements 216, a match score (or a vector of match scores) based on brand names might be calculated by one or more matching algorithms. In some embodiments, a data structure in the form of a publisher context profile data structure 400 is allocated within a computer memory and populated with data.

A publisher often publishes interests (e.g. stories related to an interest 1A04) that relate to a particular topic or a particular target demographic feature set. In some cases a publisher publishes interests that relate to a particular class of product or brand of product. Accordingly, a publisher might want to attract impression opportunities for, and emphasize ads from, a particular set of brands and/or ads that are targeted to a particular set of demographic features. Thus, an exemplary publisher context profile data structure 400 might comprise one or more impression descriptors 440₀-440_{N}. An impression descriptor might in turn comprise one or more target demographic vectors 450₀-450_{N} (including one or more demographic features 305), and one or more target brand vectors 460₀-460_{N}, and might also comprise one or more brand name association vectors 470₀-470_{N}, any of which vectors can be used by matching algorithms.

The one or more impression descriptors 440₀-440_{N} might comprise an advertiser's name and/or a URL to an advertiser's digital context(s), possibly including the URL to the specific page or pages that relate to the advertiser's product(s).

Any component of an impression descriptor might be associated with one or more target demographics; hence, the one or more target demographic vectors 450₀-450_{N} can contain one or more demographic features 305, and might serve to characterize the target demographics for each component.

Similarly, any component of an impression might be associated with one or more target brands. Hence, the one or more target brand vectors 460₀-460_{N} might serve to characterize the target brand for each component.

FIG. 5 depicts components of a system 500 for displaying advertisements related to brands inferred from user generated content. As hereinabove discussed, the presently-described systems serve to select a candidate digital advertisement 216 for placement in an impression for display on a digital display device. Such selection can include optimization based on several selection criteria, some of which selection criteria are discussed in Table 1.

TABLE 1
Possible multi-criteria selection optimization

| Primary | Secondary | Tertiary |
|---|---|---|
| Selection Criteria | Selection Criteria | Selection Criteria |
| Brand name used in text | Brand name found in the | Brand name used in (or |
| of post matches the | publisher's target brands (e.g. | inferred from) text of user post |
| candidate digital | brand vector 460) matches the | has relevance to displayed |
| advertisement 216 | candidate digital advertisement | digital context |
| | 216 | |
| Brand name inferred from | Inferred brand name found in | User demographics (e.g. |
| text of user post matches | the publisher's target brands | demographic vector 304) |
| the candidate digital | (e.g. brand vector 460) | matches the target |
| advertisement 216 | matches the candidate digital | demographics of the candidate |
| | advertisement 216 | digital advertisement 216 |
| Brand name used in (or | Inferred brand name found in | User demographics (e.g. |
| inferred from) text of user | the publisher's target brands | demographic vector 304) |
| post has further relevance | (e.g. brand vector 460) | matches the target |
| to displayed digital | matches the candidate digital | demographics of the candidate |
| content and the relevance | advertisement 216 | digital advertisement 216 |
| matches the candidate | | |
| digital advertisement 216 | | |

Selection can include optimization based on primary selection criteria alone, or primary selection criteria in combination with secondary selection criteria, or any combination of primary selection criteria, secondary selection criteria, and tertiary selection criteria.

One component of a system for displaying advertisements related to brands inferred from user generated content is the ad server 250. As shown, the ad server includes components configured to operate for the purpose of selecting and displaying content. The ad server 250 can comprise an advertisement serving module 509. In the embodiment of FIG. 5, the ad server 250 receives an ad request (e.g. an ad call) from the client system 270 over a network 265. Modules within an ad server 250 serve to collect user context information (e.g. from one or more instances of a user context profile data structure 300) pertaining to the user or the user's environment, and store such user context information (e.g. in a cache 519₁ within a user profile manager 230). In some embodiments, context information pertaining to the user or the user's environment is stored as one or more user context profile data structures 300 (e.g. user context profile data structure 300₁, user context profile data structure 300₂).

Similarly, modules within an ad server 250 serve to collect publisher context information (e.g. from one or more instances of a publisher context profile data structure 400) pertaining to the publisher or the publisher's environment, and store such publisher context information (e.g. in a cache 519₂ within a publisher profile manager 225). In some embodiments, context information pertaining to the publisher or the publisher's environment is stored as one or more publisher context profile data structures 400 (e.g. publisher context profile data structure 400₁, publisher context profile data structure 400₂).

As earlier suggested, one or more techniques for matching a particular candidate digital advertisement 216₁ from among a plurality of candidate digital advertisements 216 can include matching (at least in part) on the basis of aspects of the user and/or publisher contexts. The matching can be performed or facilitated using multiple computer-implemented methods, namely matching algorithm 515, possibly implemented in a matching module 511.

Ads may be demanded by an advertisement serving module 509, which advertisement serving module 509 can operate from any node connected to the network 265. As shown, ad server 250 contains an advertisement serving module 509, which is operable to serve out ads to the client system 270. An exemplary flow of the messages and operations involved are described as follows:
1. An ad call is made from the client system 270 by sending a message to the base content server 240, which in turn makes a request to the ad server 250.
2. The advertisement serving module 509 directs the user profile manager 230 to collect and return context information regarding the client, and based on the client context information, one or more matching algorithms 515 are selected.
3. The matching algorithms 515 parse received portions of user generated content, and match (possibly using inferences) to candidate digital advertisements 216, and score at least one top scoring ad (e.g. candidate digital advertisement 2160.
4. The top scoring ad is then passed to an advertisement serving module 509 that constructs the digital context 226 and passes it to the client system 270 for display on the client system within a publisher digital context, such as the digital context 226₂ shown within an ad area 1D14, or anywhere else on the display surface (e.g. digital context 226₀ or 226₁).

One or more matching algorithms 515 serve to match to candidate digital advertisements 216 and score at least one top scoring ad (e.g. candidate digital advertisement 216₁). For example, an algorithm 515 system can parse user generated content, determine a relationship of a user generated content 262 to a brand, and use the determined relationship to match to a candidate digital advertisement 216. In some cases, a relationship of the user generated content 262 to a brand can be determined directly by merely identifying the brand name or brand names as are found in a database of brand names (e.g. target brand vector 460).

In other embodiments, an inference (e.g. inference 517₁, inference 517₂) can be used to determine a relationship of a user generated content 262 to a brand. For example, a matching algorithm can determine the brand name referred to in the post by using (for example) a hand-coded rule set. In such a scenario, a term (e.g. “M3”) can be hand-coded as being in association with a target brand name (e.g. “BMW”). A brand name association vector 470 is an example of a hand-coded rule set for identifying the brand name or brand names as are inferred from a user generated content 262.

Of course the contents of brand name association vectors 470 need not be limited to only hand-coded associations. In some embodiments, machine learning techniques serve to create a corpus of brand terms or phrases using supervised learning techniques (e.g. using a training set) or unsupervised learning techniques, and such machine learning techniques can be deployed to populate a brand name association vector 470. Thus, if the post contains any of the learned terms or phrases, a system can determine an inference from the text of the user generated content 262 and thus the associations to corresponding brand names. The match algorithm can then match the inferred brand name to a candidate digital advertisement 216, and one or more candidate digital advertisements 216 can then be layed out as described above.

In still other embodiments involving machine learning, a system can use one or more instances of a search log 582 and, using supervised or unsupervised learning techniques, can create a corpus of learned terms or phrases, whereby the learned terms or phrases can be associated with one or more brands. Such associations can be represented in a database of brand associations 228, or in a brand name association vector 470, or any other data structure. Some possible brand associations are shown in Table 2.

TABLE 2
Possible brand association techniques

| Sample | | |
|---|---|---|
| Brand Association | Sample | Sample |
| Technique | Inputs for Inference | Brand Association Output |
| Brand name used | Text of user post | Brand name association vector |
| explicitly in text of post | | 470 |
| Trade name used | Text of user post: Inference | Brand name association vector |
| explicitly in text of post | uses brand names determined | 470 |
| | from rules | |
| Brand name inferred | Text of user posts: Inference | Learned terms or phrases |
| | uses brand names determined | (e.g. a database of brand |
| | from a plurality of user posts | associations 228) |
| Brand name inferred | Text of a search log: Inference | Learned terms or phrases |
| | uses keywords determined | (e.g. a database of brand |
| | from search logs | associations 228) |

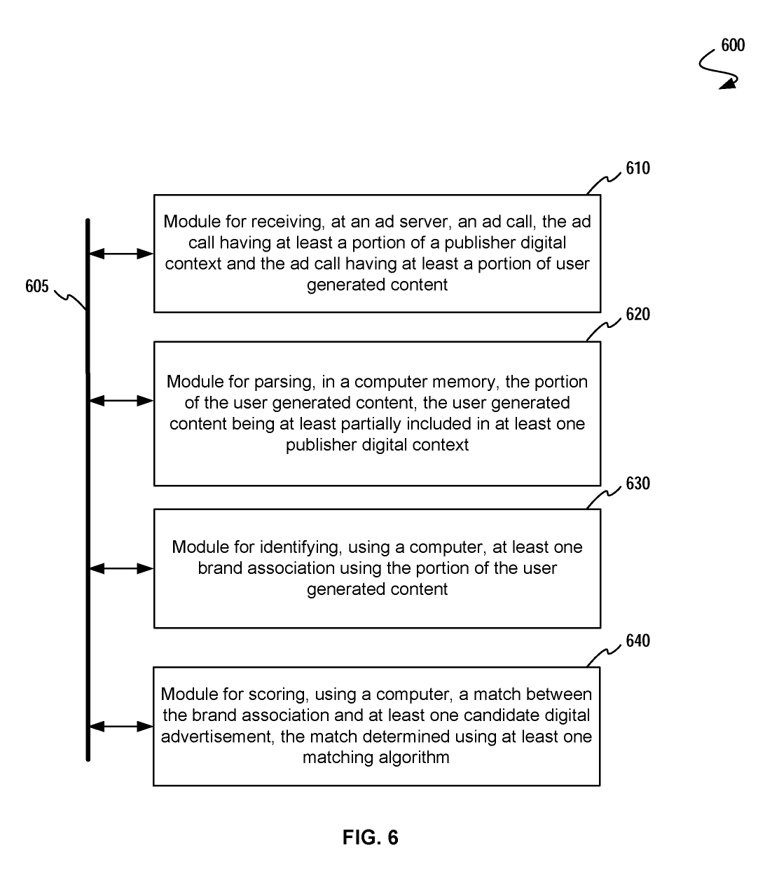

FIG. 6 depicts a block diagram of a system for displaying a digital advertisement within a digital context. As an option, the present system 600 may be implemented in the context of the architecture and functionality of the embodiments described herein. Of course, however, the system 600 or any operation therein may be carried out in any desired environment. As shown, system 600 comprises a plurality of modules, a module comprising at least one processor and a memory, each connected to a communication link 605, and any module can communicate with other modules over communication link 605. The modules of the system can, individually or in combination, perform the method steps within system 600. Any method steps performed within system 600 may be performed in any order unless as may be specified in the claims.

As shown, system 600 implements a method for displaying a digital advertisement within a digital context, the system 600 comprising modules for: receiving, at an ad server, an ad call, the ad call having at least a portion of a publisher digital context and the ad call having at least a portion of a user generated content (see module 610); parsing, in a computer memory, the portion of the user generated content, the user generated content being at least partially included in at least one publisher digital context (see module 620); identifying, using a computer, at least one brand association using the portion of the user generated content (see module 630); and scoring, using a computer, a match between the brand association and at least one candidate digital advertisement, the match determined using at least one matching algorithm (see module 640).

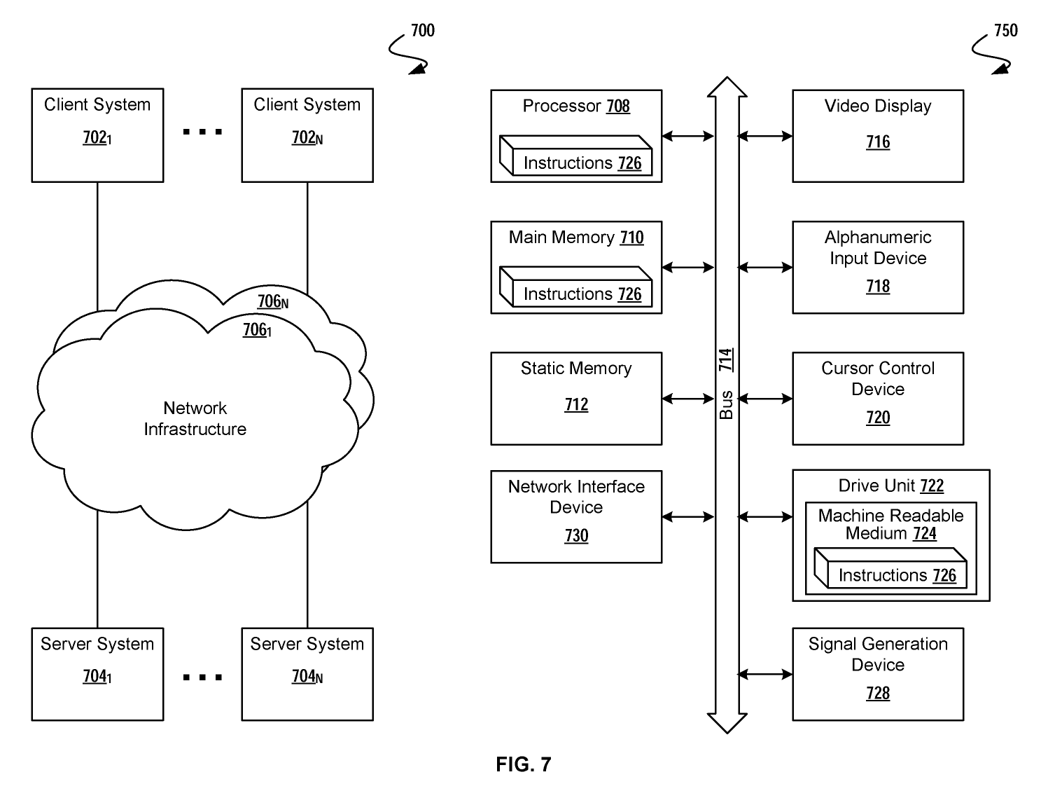

FIG. 7 is a diagrammatic representation of a network 700, including nodes for client computer systems 702₁ through 702_{N}, nodes for server computer systems 704₁ through 704_{N}, and network infrastructure nodes 706₁ through 706_{N}, according to some embodiments. The embodiment shown is purely exemplary, and might be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 750 includes a processor 708 (e.g. a processor core, a microprocessor, a computing device, etc), a main memory 710 and a static memory 712, which communicate with each other via a bus 714. The machine 750 may further include a display unit 716 that may comprise a touch-screen, or a liquid crystal display (LCD), or a light emitting diode (LED) display, or a cathode ray tube (CRT). As shown, the computer system 750 also includes a human input/output (I/O) device 718 (e.g. a keyboard, an alphanumeric keypad, etc), a pointing device 720 (e.g. a mouse, a touch screen, etc), a drive unit 722 (e.g. a disk drive unit, a CD/DVD drive, a tangible computer readable removable media drive, an SSD storage device, etc), a signal generation device 728 (e.g. a speaker, an audio output, etc), and a network interface device 730 (e.g. an Ethernet interface, a wired network interface, a wireless network interface, a propagated signal interface, etc).

The drive unit 722 includes a non-transitory machine-readable medium 724 on which is stored a set of instructions (i.e. software, firmware, middleware, etc) 726 embodying any one, or all, of the methodologies described above. The set of instructions 726 is also shown to reside, completely or at least partially, within the main memory 710 and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for displaying a digital advertisement within a digital context, comprising:
receiving, at an ad server, an ad call, the ad call having at least a portion of a publisher digital context and the ad call having at least a portion of user generated content;
parsing, in a computer memory, the portion of the user generated content, the user generated content-being at least partially included in at least one publisher digital context;
identifying, using a computer, at least one brand association using the portion of the user generated content; and
scoring, using a computer, a match between the at least one brand association and at least one candidate digital advertisement, the match determined using at least one matching algorithm.

2. The method of claim 1, further comprising displaying, on a display device, the candidate digital advertisement within the digital context.

3. The method of claim 1, wherein identifying at least one brand association uses a database of brand names.

4. The method of claim 1, wherein identifying at least one brand association uses an inference.

5. The method of claim 4 wherein the inference uses key words determined from search logs.

6. The method of claim 4, wherein the inference uses brand names determined from a plurality of user posts.

7. The method of claim 4, wherein the inference uses brand names determined from a set of rules.

8. The method of claim 1, wherein scoring a match between the brand association and at least one candidate digital advertisement comprises primary selection criteria and secondary selection criteria.

9. An advertising server network for displaying a digital advertisement within a digital context, comprising:
a module for receiving, at an ad server, an ad call, the ad call having at least a portion of a publisher digital context and the ad call having at least a portion of user generated content;
a module for parsing, in a computer memory, the portion of the user generated content, the user generated content-being at least partially included in at least one publisher digital context;
a module for identifying, using a computer, at least one brand association using the portion of the user generated content; and
a module for scoring, using a computer, a match between the brand association and at least one candidate digital advertisement, the match determined using at least one matching algorithm.

10. The advertising server network of claim 9, further comprising a module for displaying, on a display device, the candidate digital advertisement within the digital context.

11. The advertising server network of claim 9, wherein identifying at least one brand association uses a database of brand names.

12. The advertising server network of claim 9, wherein identifying at least one brand association uses an inference.

13. The advertising server network of claim 12, wherein the inference uses key words determined from search logs.

14. The advertising server network of claim 12, wherein the inference uses brand names determined from a plurality of user posts.

15. The advertising server network of claim 12, wherein the inference uses brand names determined from a set of rules.

16. The advertising server network of claim 9, wherein scoring a match between the brand association and at least one candidate digital advertisement comprises primary selection criteria and secondary selection criteria.

17. A non-transitory computer readable medium comprising a set of instructions which, when executed by a computer, cause the computer to display a digital advertisement within a digital context, the set of instructions for:
receiving, at an ad server, an ad call, the ad call having at least a portion of a publisher digital context and the ad call having at least a portion of user generated content;
parsing, in a computer memory, the portion of the user generated content, the user generated content-being at least partially included in at least one publisher digital context;
identifying, using a computer, at least one brand association using the portion of the user generated content; and
scoring, using a computer, a match between the brand association and at least one candidate digital advertisement, the match determined using at least one matching algorithm.

18. The non-transitory computer readable medium of claim 17, wherein identifying at least one brand association uses a database of brand names.

19. The non-transitory computer readable medium of claim 17, wherein identifying at least one brand association uses an inference.

20. The non-transitory computer readable medium of claim 17, wherein scoring a match between the brand association and at least one candidate digital advertisement comprises primary selection criteria and secondary selection criteria.
